(19) United States
(12) Patent Application Publication
(10) Pub. No.: US 2024/0067861 A1
(43) Pub. Date: Feb. 29, 2024

(54) METHODS AND COMPOSITIONS OF SYNTHETIC QUADRIPOLYMER BASED DIVERSION FLUIDS

(71) Applicants: SAUDI ARABIAN OIL COMPANY, Dhahran (SA); KING FAHD UNIVERSITY OF PETROLEUM & MINERALS, Dhahran (SA)

(72) Inventors: Rajendra Arunkumar Kalgaonkar, Dhahran (SA); Mohammed Abudullah Bataweel, Dhahran (SA); Manar Mohammed Alahmari, Dhahran (SA); Ali Shaikh Asrof, Dhahran (SA); Ahmad Bakr Al-Harbi, Dhahran (SA); Nisar Ullah, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 17/818,576

(22) Filed: Aug. 9, 2022

(51) Int. Cl. C09K 8/508; C08F 220/56; C09K 8/76; E21B 43/16; E21B 43/27

(52) U.S. Cl. CPC C09K 8/5083; C08F 220/56; C09K 8/76; E21B 43/16; E21B 43/27; C08F 2800/10

(57) ABSTRACT

A composition includes a polymer having a structure as shown in Formula (I):

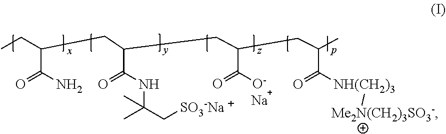

where x is from 20 to 70, y is from 20 to 30, z is from 1.0 to 10, and p is from 1.0 to 10. A method of making the polymer is also provided. The polymer composition may be used as a wellbore fluid. Also provided is a method of treating a hydrocarbon bearing formation. The method includes introducing the polymer-containing wellbore fluid into a high permeability zone of a hydrocarbon bearing formation such that it blocks at least a portion of the high permeability zone of the hydrocarbon bearing formation, stimulating the hydrocarbon bearing formation thereby creating pathways for hydrocarbon production, and recovering hydrocarbons.

### BACKGROUND

Well stimulation enables the improved extraction of hydrocarbon reserves that conventional recovery processes, such as gas or water displacement, cannot access. One well stimulation technique is matrix stimulation, which may also be referred to as matrix acidizing treatment. In matrix stimulation, an acidic fluid is injected into a formation at a pressure below the fracture pressure and is used to stimulate a reservoir by reacting with the reservoir rock, thereby dissolving the rock to create a pathway for hydrocarbon production.

However, when the acidic fluid has a low viscosity, the acid may have limited penetration into the formation and only react at the face of the rock. This is not an effective method for stimulating the reservoir as a conductive pathway for hydrocarbon production is not created. Further, most of the reservoirs have heterogeneous permeabilities which result in the low viscosity acid primarily penetrating the high permeable zones in the reservoir and leaving most of the low permeability zones untreated.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to composition comprising a polymer having a structure as shown in Formula (I):

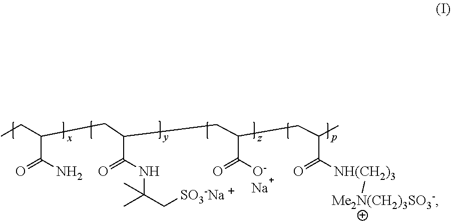

where x is from 20 to 70, y is from 20 to 30, z is from 1.0 to 10, and p is from 1.0 to 10.

In another aspect, embodiments, disclosed herein relate to a method of making a polymer composition. The method includes providing an aqueous solution comprising a first monomer, a second monomer, a third monomer and a fourth monomer, adding an initiator to the aqueous solution to form a mixture, and heating the mixture to form a polymer gel. The first monomer has a structure as shown in Formula (II):

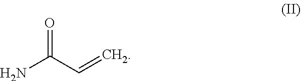

The second monomer has a structure as shown in Formula (III):

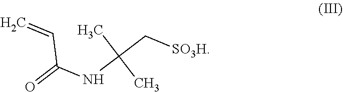

The third monomer has a structure as shown in Formula (IV):

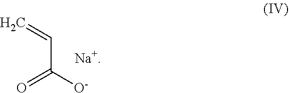

The fourth monomer has a structure as shown in Formula (V):

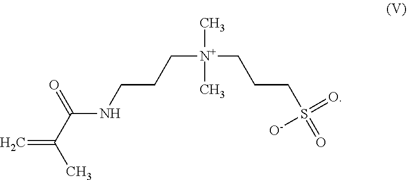 [SMILES: C=C(C)C(=O)NCCC[N+](C)(C)CCCS(=O)(=O)[O-]]

In yet another aspect, embodiments disclosed herein relate to wellbore fluid comprising the polymer having a structure as shown in Formula (I), above, and an aqueous base fluid.

In another aspect, embodiments disclosed herein relate to a method of treating a hydrocarbon bearing formation. The method includes introducing a wellbore fluid including the polymer of formula (1) and an aqueous base fluid into a high permeability zone of a hydrocarbon bearing formation, stimulating the hydrocarbon bearing formation thereby creating pathways for hydrocarbon production, and recovering hydrocarbons. The wellbore fluid has a viscosity sufficiently high such that it blocks at least a portion of the high permeability zone of the hydrocarbon bearing formation.

Other aspects and advantages of the claimed subject matter will be apparent from the following description and the appended claims.

### BRIEF DESCRIPTION OF DRAWINGS

FIG. 1 is a block flow diagram of a method of making a polymer in accordance with one or more embodiments.

FIG. 2 is a block flow diagram of a method of treating a hydrocarbon bearing formation in accordance with one or more embodiments.

FIG. 3 is a proton NMR spectrum of a polymer composition in accordance with one or more embodiments.

FIG. 4 is an FTIR spectrum of a polymer composition in accordance with one or more embodiments.

### DETAILED DESCRIPTION

Embodiments disclosed herein generally relate to a polymer composition, synthesis of the polymer, wellbore fluid compositions including the polymer, and methods of use of the wellbore fluid in processes such as acid stimulation and enhanced oil recovery (EOR). The disclosed polymer may have a high viscosity under formation conditions suitable for plugging high permeability zones of a formation. As such, methods of using the disclosed composition may modify the injection profile of the formation for a well stimulation treatment by diverting stimulation fluid to lower permeability zones of the reservoir. The disclosed polymer composition may be broken using conventional breakers for easy flowback once stimulation and/or EOR are complete.

In one aspect, embodiments disclosed herein relate to a composition comprising a polymer. The polymer has a structure as shown in Formula (I):

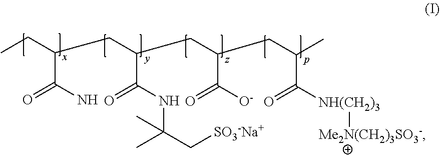

where x is from 20 to 70, y is from 20 to 30, z is from 1.0 to 10, and p is from 1.0 to 10. In particular embodiments, x is 65.5, y is 28, z is 2.5 and p is 4.

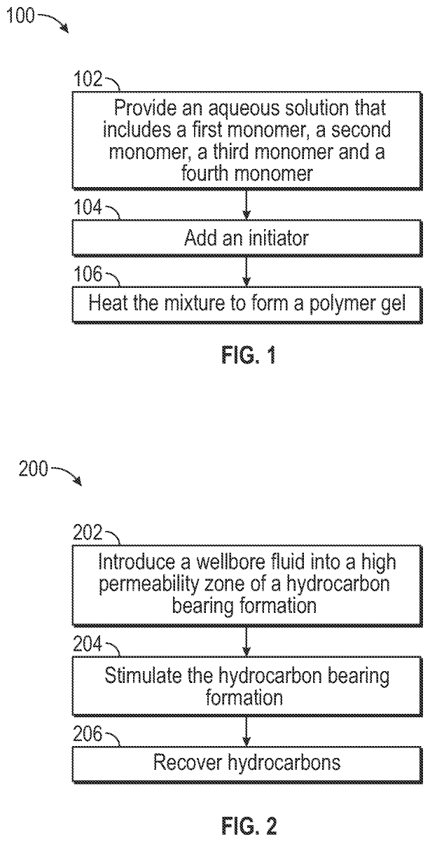

In another aspect, embodiments disclosed herein relate to a method of making the polymer as shown in Formula (I). An exemplary method 100 is shown in FIG. 1. One or more embodiments of the disclosed method include providing an aqueous solution 102 that includes a first monomer, a second monomer, a third monomer and a fourth monomer. The method 100 then includes adding an initiator 104 to the aqueous solution and heating the mixture 106 to form a polymer gel.

In the aqueous solution of one or more embodiments, the first monomer may be an aryl amide. In one or more particular embodiments, the first monomer is acrylamide and has a structure as shown in Formula (II):

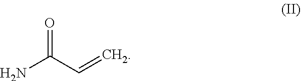

In one or more embodiments, the first monomer may be included in the aqueous solution in an amount ranging from about 40 to 60 mol % (molar percent) based on a total molar amount of the first monomer, the second monomer, the third monomer, and the fourth monomer. The first monomer may be included in an amount having a lower limit of any one of 20, 22, 25, 27, 30, 32, 35, 37, 40, 41, 42, 43, 44, 45, 46, 47, 48, 49, and 50 mol % and an upper limit of any one of 50, 51, 52, 53, 54, 55, 56, 57, 58, 59, 60, 61, 62,63, 64, 65, 66, 67, 68, 69 and 70 mol % based on a total molar amount of monomers, where any lower limit may be paired with any mathematically compatible upper limit.

In one or more embodiments, the second monomer may be 2-Acrylamido-2-methylpropane sulfonic acid (AMPS) having a structure as shown in Formula (III):

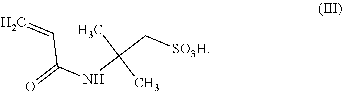

In one or more embodiments, the second monomer may be included in the aqueous solution in an amount ranging from about 20 to 30 mol % based on a total molar amount of the first monomer, the second monomer, the third monomer, and the fourth monomer. The second monomer may be included in an amount having a lower limit of any one of 20, 20.5, 21, 21.5, 22, 22.5, 23, 23.5, 24, 24.5 and 25 mol % and an upper limit of any one of 25, 25.5, 26, 26.5, 27, 27.5, 28, 28.5, 29, 29.5 and 30 mol % based on a total molar amount of monomers, where any lower limit may be paired with any mathematically compatible upper limit.

In one or more embodiments, the third monomer may be acrylic acid (AA) having a structure as shown in Formula (IV):

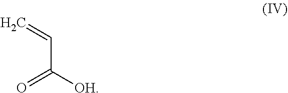

As will be appreciated by those skilled in the art, depending on the pH of a reaction mixture, the acrylic acid monomer may be present as an acrylate from an acrylate salt, such as sodium acrylate. In other embodiments, monomers having carboxylic acid functionality such as methacrylic acid may be used.

In one or more embodiments, the third monomer may be included in the aqueous solution in an amount ranging from about 1.0 to 10.0 mol % based on a total molar amount of the first monomer, the second monomer, the third monomer, and the fourth monomer. The third monomer may be included in an amount having a lower limit of any one of 1.0, 1.25, 1.5, 1.75, 2.0, 2.25, 2.5, 2.75, 3.0, 3.25, 3.5, 3.75, 4.0, 4.25, 4.5, 4.75 and 5.0 mol % and an upper limit of any one of 5.25, 5.5, 5.75, 6.0, 6.25, 6.5, 6.75, 7.0, 7.25, 7.5, 7.75, 8.0, 8.25, 8.5, 8.75, 9.0, 9.25, 9.5, 9.75, and 10.0 mol % based on a total molar amount of monomers, where any lower limit may be paired with any mathematically compatible upper limit.

In one or more embodiments, the fourth monomer has a structure as shown in Formula (V):

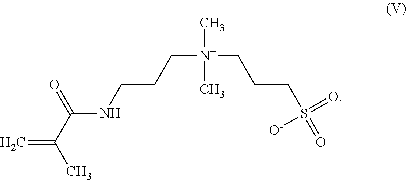 [SMILES: C=C(C)C(=O)NCCC[N+](C)(C)CCCS(=O)(=O)[O-]]

In one or more embodiments, the fourth monomer may be included in the aqueous solution in an amount ranging from about 1.0 to 10.0 mol % based on a total molar amount of the first monomer, the second monomer, the third monomer, and the fourth monomer. The fourth monomer may be included in an amount having a lower limit of any one of 1.0, 1.25, 1.5, 1.75, 2.0, 2.25, 2.5, 2.75, 3.0, 3.25, 3.5, 3.75, 4.0, 4.25, 4.5, 4.75 and 5.0 mol % and an upper limit of any one of 5.25, 5.5, 5.75, 6.0, 6.25, 6.5, 6.75, 7.0, 7.25, 7.5, 7.75, 8.0, 8.25, 8.5, 8.75, 9.0, 9.25, 9.5, 9.75, and 10.0 mol % based on a total molar amount of monomers, where any lower limit may be paired with any mathematically compatible upper limit.

In the method according to one or more embodiments, the aqueous solution of the first, second, third and fourth monomers as described above may be provided 102 at or near room temperature. In one or more embodiments, after the aqueous solution of the first, second, third and fourth monomers as described above is provided 102, the pH of the aqueous solution may be adjusted to a suitable pH for the polymerization reaction. Thus, in one or more embodiments, prior to adding the initiator, a strong base, such as sodium hydroxide, may be added to the aqueous solution until a pH of from 6.5 to 7.5 is reached.

Once the pH is adjusted to an appropriate range, method 100 includes adding an initiator 104 to the aqueous solution to initiate polymerization of the monomers. Any suitable water-soluble initiator can be used. For example, in one or more embodiments, the initiator may be a free radical initiator, such as 2,2′-Azobis(2-methylpropionamidine) dihydrochloride. In other embodiments, the initiator may be K₂S₂O₈.

After the initiator has been added 104, the mixture is heated 106 for a period of time to form a polymer gel. The heating may be conducted at a suitable temperature for a period of time long enough to complete the polymerization reaction. In one or more embodiments, the heating may be conducted at a temperature between 40° C. and 60° C. The duration of the heating step of one or more embodiments may be from 1 hour to 10 hours.

In one or more embodiments, after the heating the mixture 106, the polymer gel may be freeze dried to obtain a polymer powder. The freeze-drying step is conducted to effectively remove water from the system, and may be performed by exposing the mixture to liquid nitrogen. The polymer powder may be used in wellbore fluids, as described below.

In another aspect, embodiments disclosed herein relate to a wellbore fluid comprising the previously described polymer. The wellbore fluids of one or more embodiments may include, for example, aqueous-based wellbore fluids. The wellbore fluids may be acid stimulation fluids, EOR fluids, or fracturing fluids, among others.

In one or more embodiments, the water-based wellbore fluids may comprise an aqueous fluid. The aqueous fluid may include at least one of fresh water, seawater, brine, water-soluble organic compounds, and mixtures thereof. The aqueous fluid may contain fresh water formulated to contain various salts, to the extent that such salts do not detrimentally change the viscosity of the wellbore fluid. The salts may include, but are not limited to, alkali metal halides and hydroxides. In one or more embodiments, brine may be any of seawater, aqueous solutions wherein the salt concentration is less than that of seawater, or aqueous solutions wherein the salt concentration is greater than that of seawater. Salts that are found in seawater may include sodium, calcium, aluminum, magnesium, potassium, strontium, and lithium salts of halides, carbonates, chlorates, bromates, nitrates, oxides, phosphates, among others. Any of the aforementioned salts may be included in brine. In one or more embodiments, the density of the aqueous fluid may be controlled by increasing the salt concentration in the brine, though the maximum concentration is determined by the solubility of the salt. In particular embodiments, brine may include an alkali metal halide or carboxylate salt and/or alkaline earth metal carboxylate salts.

The wellbore fluid may include the polymer having a structure as shown in Formula (I) above. The polymer may be included in the wellbore fluid in an amount sufficient to increase the viscosity of the wellbore fluid for diversion of fluids away from high permeability zones, for example. The polymer may be included in the wellbore fluid in an amount ranging from about 1.0 to 15 wt. % based on the total weight of the wellbore fluid. The polymer may be included in the wellbore fluid in an amount having a lower limit of one of 1.0, 2.0, 3.0, 4.0, 5.0, 6.0, 7.0, and 8.0 wt % and an upper limit of any one of 7.0, 8.0, 9.0, 10.0, 11.0, 12.0, 13.0, 14.0, and 15.0, where any lower limit may be paired with any mathematically compatible upper limit.

The wellbore fluids of one or more embodiments may include one or more acids. Acids may be particularly included when the wellbore fluid is to be used in a matrix stimulation process, as described below. The acid may be any suitable acid known to a person of ordinary skill in the art, and its selection may be determined by the intended application of the fluid. In some embodiments, the acid may be one or more selected from the group consisting of hydrochloric acid, sulfuric acid, carboxylic acids such as acetic acid, and hydrofluoric acid. In some embodiments, the hydrofluoric acid may be included as a hydrogen fluoride source, such as ammonium fluoride, ammonium bifluoride, fluoroboric acid, hexafluorophosphoric acid, and the like.

The wellbore fluid of one or more embodiments may comprise the one or more acids in a total amount of the range of about 0.01 to 30.0 wt. %. For example, the wellbore fluid may contain the acids in an amount ranging from a lower limit of any of 0.01, 0.05, 0.1, 0.5, 1.0, 5.0, 10, 15, 20, and 25 wt. % to an upper limit of any of 0.5, 1.0, 5.0, 10, 15, 20, 25, 28 and 30 wt. %, where any lower limit can be used in combination with any mathematically-compatible upper limit.

The wellbore fluids of one or more embodiments may include one or more additives. The additives may be any conventionally known and one of ordinary skill in the art will, with the benefit of this disclosure, appreciate that the selection of said additives will be dependent upon the intended application of the wellbore fluid. For instance, if the wellbore fluid is to be used as a fracturing fluid, it may comprise a proppant such as sand. In some embodiments, the additives may be one or more selected from clay stabilizers, scale inhibitors, corrosion inhibitors, biocides, friction reducers, thickeners, and the like.

The wellbore fluid of one or more embodiments may comprise the one or more additives in a total amount of the range of about 0.01 to 15.0 wt. %. For example, the wellbore fluid may contain the additives in an amount ranging from a lower limit of any of 0.01, 0.05, 0.1, 0.5, 1.0, 2.5, 5.0, 1.5, 10.0 and 12.5 wt. % to an upper limit of any of 0.1, 0.5, 1.0, 2.5, 5.0, 7.5, 10.0, 12.5, and 15.0 wt. %, where any lower limit can be used in combination with any mathematically-compatible upper limit.

In one or more embodiments, the wellbore fluid may have a viscosity of at least 50 centipoises (cP) at a shear rate of 100 l/s at 75° F. For example, the wellbore fluid may have a viscosity of at least 50, 51, 52, 53, 54, 55, 56, 57, 58, 59, 60, 65, 70, 75, 80, 85, or 90 cP.

In yet another aspect, embodiments disclosed herein relate to a method of treating a hydrocarbon bearing formation. A method in accordance with one or more embodiments is shown in FIG. 2. The method 200 includes introducing a wellbore fluid 202 into a high permeability zone of a hydrocarbon bearing formation. When introduced, the wellbore fluid has a viscosity sufficiently high such that it blocks/plugs at least a portion of the high permeability zone of the hydrocarbon bearing formation. The method 200 then includes stimulating the hydrocarbon bearing formation 204 thereby creating pathways for hydrocarbon production and then recovering hydrocarbons 206. The wellbore fluid is as previously described.

In one or more embodiments, the wellbore fluid may be a single treatment fluid that is injected into the wellbore in one pumping stage, which both plugs permeable zones of the formation and also stimulates the formation. In other embodiments, methods in accordance with the present disclosure may involve the injection of the wellbore fluid and one or more additional stimulation fluids. The additional stimulation fluids may, in some embodiments, be co-injected with the wellbore fluid. In some embodiments, the stimulation fluids may be injected after the wellbore fluid.

The methods of one or more embodiments of the present disclosure may further comprise a pre-flushing step before the injection of the wellbore fluid. The pre-flushing step may comprise flushing the formation with a flushing solution that comprises one or more surfactants. The flushing solution may be an aqueous solution. The suitability of the use of a pre-flushing step may depend on the type of surfactant and rock.

The hydrocarbon-containing formation of one or more embodiments may be a formation containing multiple zones of varying permeability. For instance, the formation may contain at least a zone having a relatively higher permeability and a zone having a relatively lower permeability. During conventional injection, fluids preferentially sweep the higher permeability zone, leaving the lower permeability zone incompletely swept. In one or more embodiments, the increased viscosity of the wellbore fluid may “plug” the higher permeability zone, allowing subsequent fluid to sweep the low permeability zone and improving sweep efficiency.

In one or more embodiments, the formation may have a temperature ranging from about 60 to 250° C. For example, the formation may have a temperature that is of an amount ranging from a lower limit of any of 60, 70, 80, 90, 100, 120, 140, 160, 180, and 200° C. to an upper limit of any of 100, 120, 140, 160, 180, 200, 225, and 250° C., where any lower limit can be used in combination with any mathematically-compatible upper limit.

The well stimulation process of one or more embodiments may be a matrix stimulation process. In the matrix stimulation process of one or more embodiments, the wellbore fluid, or one of the stimulation fluids, contains an acid. The acid fluid may react with the formation, dissolving rock, and creating wormholes that create a pathway for hydrocarbons to be displaced from deeper within the rock. In one or more embodiments, the wellbore fluid may increase in viscosity in the formation, enabling the fluid to better penetrate lower-permeability zones of the formation and allowing the acid to more uniformly react with the entire formation. This may provide for the formation of deeper wormholes and enhancing the overall permeability of the near-wellbore region. In the absence of this viscosity increase, the fluid will primarily penetrate the high permeability zones.

In one or more embodiments, the well stimulation process may be repeated one or more times to increase the amount of hydrocarbons recovered. In some embodiments, subsequent well stimulation processes may involve the use of different amounts of the surfactant and/or different surfactants than the first. The methods of one or more embodiments may advantageously provide improved sweep efficiency.

In one or more embodiments, after the formation has been stimulated, the polymer of the wellbore fluid may be broken using a breaker. Thus, when a breaker is introduced into the high permeability zone of the hydrocarbon bearing formation the viscosity of the wellbore fluid may be decreased for easy flowback. The viscosity may be decreased to a value of 10 cp (centipoise) or less at room temperature. Examples of a breaker include an acid, an oxidizer, an enzyme breaker, a chelating agent, or a combination thereof. Examples of a breaker may also include, but are not be limited to, sodium bromate, potassium bromate, sodium persulfate, ammonium persulfate, potassium persulfate, and various peroxides.

Embodiments of the present disclosure may provide at least one of the following advantages. Due to the high viscosity of the disclosed wellbore fluid, the wellbore fluid may block or plug high permeability zones of a formation such that the tail-end of the wellbore fluid is diverted to lower-permeability zones of the formation, displacing hydrocarbons. This effect may improve oil recovery in formations having mixed permeability zones.

### EXAMPLES

### Materials

The acrylamide used in the experiments had a purity of above 99% and was sourced from Merck Schuchardt OHG. The AMPS had a purity of 99% and sourced from Sigma-Aldrich. The (3-methacrolylamine)propyl] dimethyl (3-sulfopropyl)-ammonium hydroxide inner salt had a purity of 95% and was sourced from BOC Sciences. 2,2′-Azobis(2-methylpropionamidine) dihydrochloride or AMPD had a purity of 97% and was sourced from Sigma-Aldrich. The additives, biocide M275, clay stabilizer L071, and surfactant F111 were obtained from Schlumberger. The surfactant F111 is a microemulsion flow back surfactant.

### Example 1

### Polymer Synthesis

A solution of acrylamide (4.0 g, 56.3 mmol), AMPS (5.0 g, 24.1 mmol), acrylic acid (0.200 g, 2.12 mmol) and [(3-methacrolylamine)propyl] dimethyl (3 -sulfopropyl)-ammonium hydroxide inner salt (1.0 g, 3.42 mmol) in distilled water (45 mL) was adjusted to a pH 7 by the dropwise addition of ≈5 M NaOH (5.1 g). The solution was purged with N₂. After addition of initiator AMPD (27 mg, 0.100 mmol), the mixture was stirred and heated under N₂ in the sealed flask at 50° C. for 4 h. The stirring was stopped once a thick polymer formed. The resultant transparent gel reaction mixture was then freeze-dried to obtain polymer 1 (10.7 g, ≈100% yield) as a white powder. The yield of 100% may be due to trace amounts of excess moisture.

Three polymers were made according to the procedure described above with different mole ratios of each monomer. The three compositions are shown in Table 1, below. The notations of x, y, z and p on Table 1 correspond to x, y, z and p as shown in Formula (I), above.

TABLE 1

| | Mol (%) | | | |
|---|---|---|---|---|
| Polymer | x | y | z | p |
| 1 | 66.6 | 22.8 | 2.5 | 8.1 |
| 2 | 74.7 | 12.8 | 3.4 | 9.1 |
| 3 | 65.5 | 28.0 | 2.5 | 4.0 |

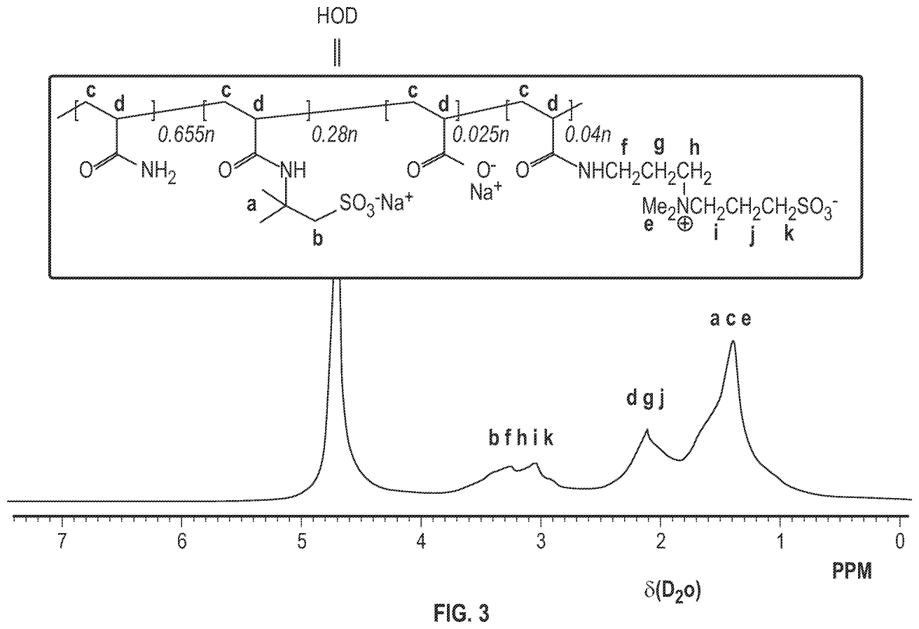

Polymer 3 showed the best performance and was characterized further to confirm the structure. The chemical structure of Polymer 3 was confirmed using proton NMR. The ¹H NMR spectrum of polymer 1 and the corresponding labeled chemical structure is shown in FIG. 3. The chemical shifts of several protons in the polymers are indicated in the Figure. The composition of the monomers incorporated into the polymer backbones is expected to match the feed composition since the monomer conversions are almost 100% as supported by NMR spectral analysis where the absence of alkene protons at δ6-8 ppm was confirmed. Area integration of several protons also indicated the compositions of the monomer incorporation were same as feed ratio within an instrumental error of ±2 mol %.

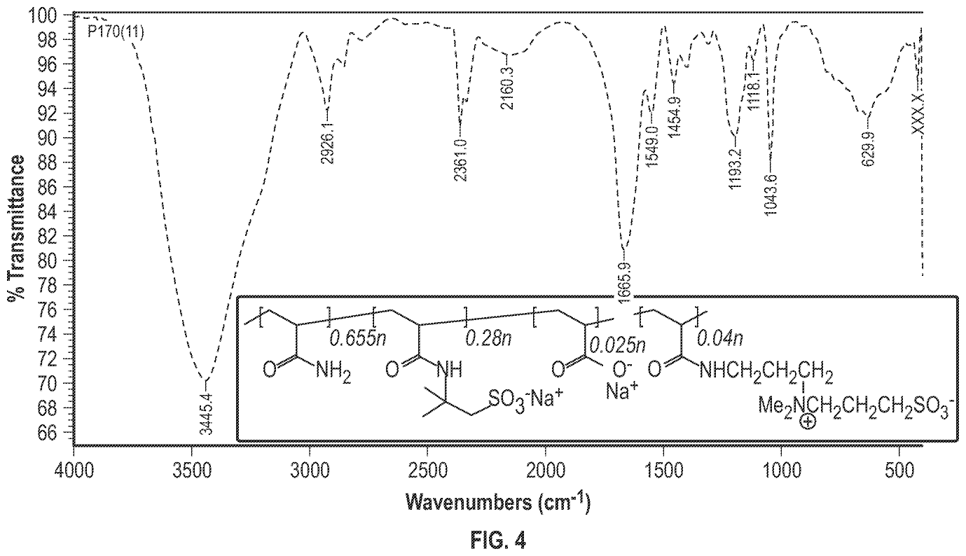

The FTIR data of the polymer is shown in FIG. 4 and further confirms the structure.

### Example 2

### Wellbore Fluid Preparation

A diversion fluid including polymer 1 was prepared as follows. First, 1 liter (L) of tap water was added to a Waring blender. A biocide, M275, was then added to the Waring blender in an amount of 0.5 gallons of M275 per 1000 gallons (gpt) of water. As used herein, gpt refers to gallons per 1000 gallons. Next, the polymer was added to the Waring blender in an amount of 45 pounds polymer 1 per 1000 gallons (gpt) of water. 1 gpt of 20% (volume by volume) acetic acid was then added to the mixture in the Waring blender. The polymer was then hydrated for about 30 minutes. After that a series of additives were added to the mixture, including 40 parts per trillion (ppt) of Na₂S₂O₃-5H₂O, 3 ppt of Na₂CO₃, 5 gpt of Ethox 3571, 1.5 gpt of L071 clay stabilizer, and 2 gpt of F111 microemulsion flowback surfactant. The mixture was then stirred for about 5 minutes to ensure uniform mixing of the additives. The composition of the diversion fluid is shown in Table 2.

TABLE 2

| | Amount (weight |
|---|---|
| Component | percent) |
| 20% acetic acid | 1 gpt |
| Polymer | 4.5 |
| Sodium thiosulfate | 4 |
| Sodium carbonate | 0.3 |
| Ethox 3571 | 0.5 |
| M275 | 0.05 |
| L071 | 0.15 |
| F111 | 0.2 |

In order to test the viscosity of the prepared diversion fluid, about 300 mL of the prepared polymer fluid was transferred to the cup of a Fann 35 viscometer. Viscosity of the fluid was measured using a R1B1 rotor and bob combination. The RPM related to the corresponding shear rate was selected and the viscosity was monitored for about 30 minutes to ensure that the reading is stable. All viscosity measurements were carried out at 75° F. The viscosity data at different shear rates are shown in Table 3.

TABLE 3

| | Viscosity (cp) | | |
|---|---|---|---|
| Shear Rate (1/s) | Polymer 1 | Polymer 2 | Polymer 3 |
| 102 | 120 | 70 | 253 |
| 170 | 75 | 33 | 129 |
| 511 | 30 | 15 | 65 |

As shown, at varying shear rates, the diversion fluid including the disclosed polymer had a high viscosity. Polymer 3 performed particularly well. Each of the polymer demonstrated a viscosity high enough to be used as a diversion fluid.

The viscosity of the polymers may be broken with an oxidizer breaker for easy flowback. This was confirmed using static breaker tests. First, 100 mL of the fluid sample prepared as discussed in Example 2 was take in a glass bottle. A 4 ppt solution of NaBrO₃ live breaker solution was added to the fluid and mixed well. The bottle was capped and kept in a water bath at 120° F. for 24 hours to ensure complete breaking of the polymer. The viscosity of the broken polymer fluid was then recorded using a Fann 35 viscometer at 511 l/s shear rate. Static break tests showed that the fluid viscosity reduced to less than 10 cp at room temperature at 511 s⁻¹ shear rate using 4 ppt NaBrO₃ live breaker.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A composition comprising:
a polymer having a structure as shown in Formula (I): 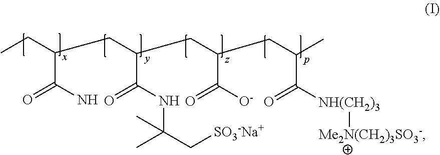
where x is from 20 to 70, y is from 20 to 30, z is from 1.0 to 10, and p is from 1.0 to 10.

2. The composition of claim 1, where x is 65.5, y is 28, z is 2.5 and p is 4.

3. A method of making a polymer composition, the method comprising:
providing an aqueous solution comprising a first monomer, a second monomer, a third monomer and a fourth monomer;
adding an initiator to the aqueous solution to form a mixture; and
heating the mixture to form a polymer gel,
wherein the first monomer has a structure as shown in Formula (II): 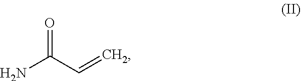
wherein the second monomer has a structure as shown in Formula (III): 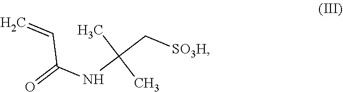
wherein the third monomer has a structure as shown in Formula (IV): 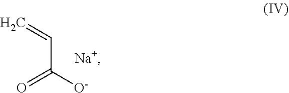
and
wherein the fourth monomer has a structure as shown in Formula (V):

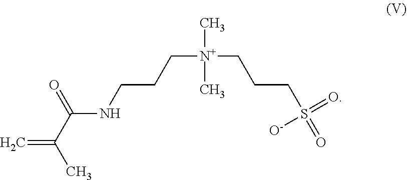 [SMILES: C=C(C)C(=O)NCCC[N+](C)(C)CCCS(=O)(=O)[O-]]

4. The method of claim 3, wherein the aqueous solution comprises from 40 to 60 mol % of the first monomer based on a total molar amount of the first monomer, the second monomer, the third monomer, and the fourth monomer.

5. The method of claim 3, wherein the aqueous solution comprises from 20 to 30 mol % of the second monomer based on a total molar amount of the first monomer, the second monomer, the third monomer, and the fourth monomer.

6. The method of claim 3, wherein the aqueous solution comprises from 1.0 to 10 mol % of the third monomer based on a total molar amount of the first monomer, the second monomer, the third monomer, and the fourth monomer.

7. The method of claim 3, wherein the aqueous solution comprises from 1.0 to 10 mol % of the fourth monomer based on a total molar amount of the first monomer, the second monomer, the third monomer, and the fourth monomer.

8. The method of claim 3, further comprising, prior to adding the initiator, adding sodium hydroxide to the aqueous solution until a pH of from 6.5 to 7.5 is reached.

9. The method of claim 3, further comprising, after the heating the mixture, freeze drying the polymer gel to obtain a polymer powder.

10. The method of claim 3, wherein the heating comprises heating to a temperature between 40° C. and 60° C. for a time of from 1 hour to 10 hours.

11. The method of claim 3, wherein the initiator is 2,2′-Azobis(2-methylpropionamidine) dihydrochloride.

12. A wellbore fluid comprising:
a polymer having a structure as shown in Formula (I): 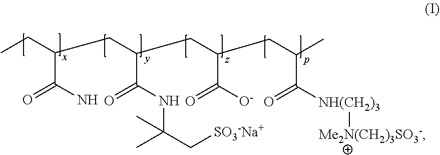
where x is from 20 to 70, y is from 20 to 30, z is from 1.0 to 10, and p is from 1.0 to 10; and
an aqueous base fluid.

13. The wellbore fluid of claim 12, comprising from 1.0 to 15 wt. % of the polymer.

14. The wellbore fluid of claim 12, further comprising an acid.

15. The wellbore fluid of claim 12, wherein the aqueous base fluid is selected from the group consisting of fresh water, seawater, and combinations thereof.

16. A method of treating a hydrocarbon bearing formation, the method comprising:
introducing the wellbore fluid of claim 12 into a high permeability zone of a hydrocarbon bearing formation, wherein the wellbore fluid has a viscosity sufficiently high such that it blocks at least a portion of the high permeability zone of the hydrocarbon bearing formation;
stimulating the hydrocarbon bearing formation thereby creating pathways for hydrocarbon production; and
recovering hydrocarbons.

17. The method of claim 16, wherein the wellbore fluid comprises from 1.0 to 15 wt. % of the polymer.

18. The method of claim 16, further comprising, after stimulating the hydrocarbon bearing formation, introducing a breaker into the high permeability zone of the hydrocarbon bearing formation thereby reducing the viscosity of the wellbore fluid.

19. The method of claim 16, wherein the stimulation comprises introducing an acid stimulation composition into the hydrocarbon bearing formation.

20. The method of claim 16, wherein the wellbore fluid further comprises an acid.
